(19) United States
(12) Patent Application Publication
(10) Pub. No.: US 2007/0043231 A1
(43) Pub. Date: Feb. 22, 2007

(54) PROCESS FOR PREPARING SULFONYLIMIDES AND DERIVATIVES THEREOF

(76) Inventors: Amer Hammami, Ville Mont-Royal, QC (CA); Benoit Marsan, Sainte-Julie, QC (CA)

Correspondence Address: BERESKIN AND PARR, 40 KING STREET WEST, BOX 401, TORONTO, ON, M5H 3Y2, CA

(21) Appl. No.: 11/465,954

(22) Filed: Aug. 21, 2006

Related U.S. Application Data
(60) Provisional application No. 60/709,828, filed on Aug. 22, 2005.

(51) Int. Cl. C07F 7/10; C01B 21/00

(52) U.S. Cl. 556/412; 423/351

(57) ABSTRACT

There are provided processes for preparing compounds of formula (I):

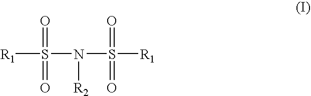

wherein each of the R₁ is independently F, Cl, Br, or I; and R₂ is H, Li, Na, K, or Cs. The processes are particularly useful for preparing compounds used in the field of electrochemistry.

### CROSS-REFERENCE TO RELATED APPLICATION

The present application claims priority on U.S. provisional application No. 60/709,828 filed on Aug. 22, 2005.

### FIELD OF THE INVENTION

The present invention relates to the field of sulfonylimides and derivatives thereof. In particular, it relates to a process for preparing such compounds, which are useful in numerous fields such as electrochemistry.

### BACKGROUND OF THE INVENTION

Salts of bis(fluorosulfonyl)imide have been used in the field of electrochemistry. More particularly, its lithium salt has been proposed for replacing LiPF₆ in lithium batteries. Various processes have been suggested so far for preparing bis(fluorosulfonyl)imide, salts thereof or intermediates thereof but these proposed processes include several drawbacks.

It would therefore be highly desirable to be provided with a process for preparing sulfonylimides and derivatives thereof such as salts thereof, which would overcome the previously mentioned drawbacks.

### SUMMARY OF THE INVENTION

In accordance with one aspect of the present invention there is provided a process for preparing a compound of formula (I): 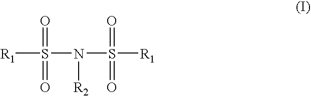
wherein

each of the R₁ is independently F, Cl, Br, or I; and

R₂ is H, Li, Na, K, or Cs,
comprising the step of reacting a compound of formula (II): 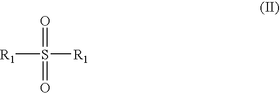
wherein each of the R₁ is as previously defined,

with a compound of formula (III): 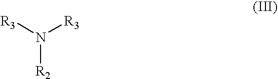
wherein

R₂ is as previously defined for formula (I); and

each of the R₃ is independently H, Li, Na, K, Cs, or (R₄)₃Si—, each of the R₄ being independently a C₁-C₁₂ alkyl.

It was found that such a process is useful and efficient to prepare, at low costs, compounds of general formula (I). This process is simple and can easily be carried out. The process is also very interesting since it permits to obtain compounds which are substantially free from contaminants i.e., it is possible to obtain compounds of formula (I) which are substantially free from traces of the reactants (or intermediates) used during the process.

It was also found that when a base such as 1,1,1,3,3,3-hexamethyldisilazane or a salt thereof (Na, Li or K) is used, the by-product so formed, trimethylsilylhalide (such as trimethylsilylchloride, or trimethylsilylfluoride) is volatile, thereby driving the reaction. Such a volatile product can thus easily be separated from the desired product.

It was also found that by using such a process, bis(fluorosulfonyl)imides and derivatives thereof can be prepared in one step by using SO₂F₂ and a base as previously defined (compound (III)).

According to another aspect of the present invention, there is provided a process for preparing a compound of formula (Ia): 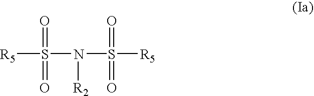
wherein

R₅ is F, Cl, Br, or I; and

R₂ is H, Li, Na, K, or Cs,

comprising the steps of:

a) reacting SO₂Cl₂ with a compound of formula (III): 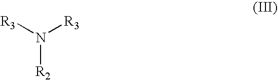
wherein

R₂ is as previously defined for formula (Ia); and

each of the R₃ is independently H, Li, Na, K, Cs, or (R₄)₃Si—, each of the R₄ being independently a C₁-C₁₂ alkyl,

so as to obtain a compound of formula (Ib); 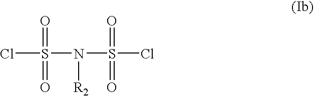
wherein

R₂ is as previously defined in formula (Ia); and

b) reacting the compound of formula (Ib) with a compound of formula MR₅, wherein M is Li, Na, K, H, Cs or (R₄)₃Si—, each of the R₄ being independently a C₁-C₁₂ alkyl, and R₅ is as previously defined in formula (Ia), so as to obtain the compound of formula (Ia).

According to another aspect of the present invention, there is provided a process for preparing a compound of formula (Ic): 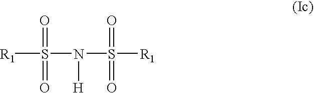
wherein

each of the R₁ is independently F, Cl, Br, or I

comprising the steps of:

a) reacting a compound of formula (II): 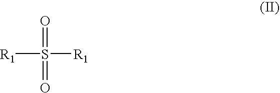
wherein each of the R₁ is as previously defined in formula (Ic),

with a compound of formula (III): 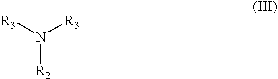
wherein

R₂ is Li, Na, K, or Cs

each of the R₃ is independently H, Li, Na, K, Cs, or (R₄)₃Si—, each of the R₄ being independently a C₁-C₁₂ alkyl,

so as to obtain a compound of formula (I); 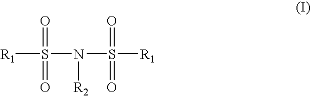
wherein

each of the R₁ is as previously defined in formula (Ic); and

R₂ is as previously defined in formula (III), and

b) treating the compound of formula (I) with a source of proton so as to obtain the compound of formula (Ic).

According to another aspect of the present invention, there is provided a process for preparing a compound of formula (V): 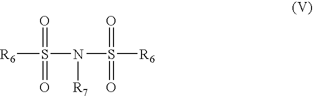
wherein

R₆ is —PPh₂, —CN, —CF₃, —C₂F₅, —N(R₄)₂, —N═PPh₃, or —F, each of the R₄ being independently a C₁-C₁₂ alkyl; and

R₇ is H, Li, Na, K, , Cs or (R₄)₃Si—, each of the R₄ being independently a C₁-C₁₂ alkyl,

comprising the steps of:

a) reacting a compound of formula (II): 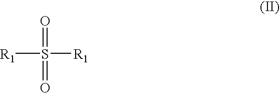
wherein

each of the R₁ is independently F, Cl, Br, or I,

with a compound of formula (III): 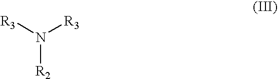
wherein

R₂ is Li, Na, K, or Cs,

each of the R₃ is independently H, Li, Na, K, Cs, or (R₄)₃Si—, each of the R₄ being independently a C₁-C₁₂ alkyl,

so as to obtain a compound of formula (I); 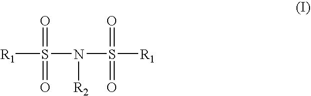
wherein

each of the R₁ is as previously defined for formula (II); and

R₂ is as previously defined for formula (III);

b) reacting the compound of formula (I) with a compound of formula R₆—R₇, wherein R₆ and R₇ are as previously defined in formula (V), so as to obtain the compound of formula (V).

According to another aspect of the present invention, there is provided a process for preparing a compound of formula (VI): 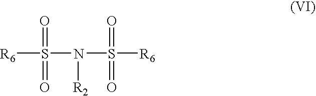
wherein

R₆ is —PPh₂, —CN, —CF₃, —C₂F₅, —N(R₄)₂, —N═PPh₃, or —F, each of the R₄ being independently a C₁-C₁₂ alkyl; and

R₂ is H, Li, Na, K, or Cs

comprising the steps of:

a) reacting a compound of formula (II): 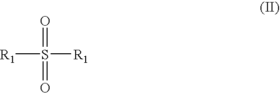
wherein

each of the R₁ is independently F, I, Br or Cl,

with a compound of formula (III): 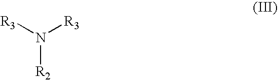
wherein

R₂ is Li, Na, K, or Cs; and

each of the R₃ is independently H, Li, Na, K, Cs, or (R₄)₃Si—, each of the R₄ being independently a C₁-C₁₂ alkyl,

so as to obtain a compound of formula (I); 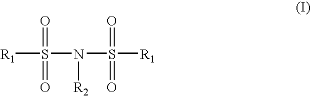
wherein

each of the R₁ is as previously defined for formula (II); and

R₂ is as previously defined for formula (III);

b) reacting the compound of formula (I) with a compound of formula R₆—R₇, wherein R₆ is as previously defined in formula (V), and R₇ is of formula (R₄)₃Si—, each of the R₄ being independently a C₁-C₁₂ alkyl, so as to obtain the compound of formula (VI).

According to another aspect of the present invention, there is provided a process for preparing a compound of formula (Ia): 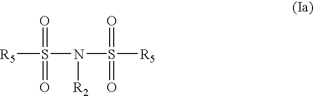
wherein

R₅ is F, Br, Cl or I; and

R₂ is H, Li, Na, K, or Cs

the process comprising:

a) reacting a compound of formula (II): 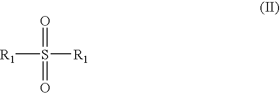
wherein each of the R₁ is independently F, Cl, Br, or I,

with a compound of formula (III): 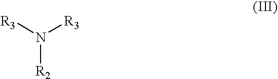
wherein

R₂ is as previously defined for formula (Ia); and

each of the R₃ is independently H, Li, Na, K, Cs, or (R₄)₃Si—, each of the R₄ being independently a C₁-C₁₂ alkyl,

so as to obtain a compound of formula (I) 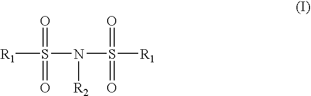
wherein

each of the R₁ is as previously defined; and

R₂ is as previously defined,

b) reacting the compound of formula (I) with a compound of formula MR₅, wherein M is H, Li, Na, K, Cs, or is of formula (R₄)₃Si—, each of said R₄ being independently a C₁-C₁₂ alkyl, and R₅ is as previously defined in formula (Ia), so as to obtain the compound of formula (Ia).

According to another aspect of the present invention, there is provided a method of using a compound of formula (II): 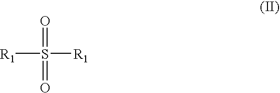
wherein each of the R₁ is independently F, Cl, Br, or I, the method comprising reacting the compound of formula (II) with a silylamide base in order to produce a sulfonylimide, a salt or derivative thereof.

According to another aspect of the present invention, there is provided the use of SO₂Cl₂ as a reactant in the preparation of a compound of formula (Ib): 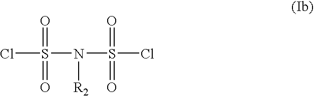
in which R₂ is H, Li, Na or K.

SO₂Cl₂ can be reacted with a silylamide base comprising a bond N—R₂.

According to another aspect of the present invention, there is provided the use of SO₂F₂ as a reactant in a process for preparing of a compound of formula (Id): 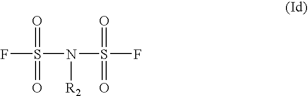
in which R₂ is H, Li, Na or K.

SO₂F₂ can be reacted with a silylamide base comprising a bond N—R₂.

According to another aspect of the present invention, there is provided the use of FSO₂Cl as a reactant in a process for preparing of a compound of formula (Ib), (Id) or (Ie): 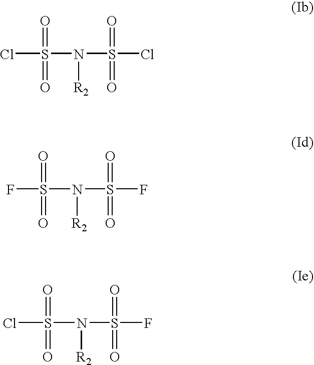
in which R₂ is H, Li, Na or K.

FSO₂Cl can be reacted with a silylamide base comprising a bond N—R₂.

According to another aspect of the present invention, there is provided the use of FSO₂Br as a reactant in a process for preparing of a compound of formula (Id), (If) or (Ig): 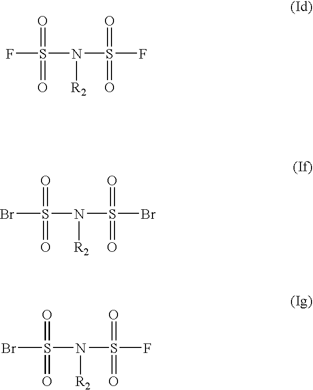
in which R₂ is H, Li, Na or K.

FSO₂Br can be reacted with a silylamide base comprising a bond N—R₂.

According to another aspect of the present invention, there is provided a process for preparing a compound of formula (Ib): 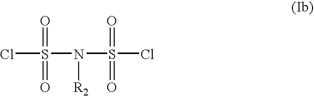
in which R₂ is H, Li, Na or K,

comprising the step of reacting SO₂Cl₂ with a silylamide base comprising a bond N—R₂.

According to another aspect of the present invention, there is provided a process for preparing a compound of formula (Id): 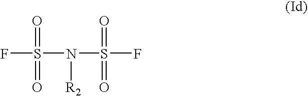
in which R₂ is H, Li, Na or K,

comprising the step of reacting SO₂F₂ with a silylamide base comprising a bond N—R₂.

According to another aspect of the present invention, there is provided a compound of formula (V): 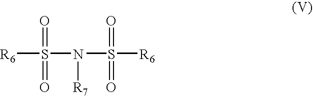
wherein

each of R₆ is independently —PPh₂, —CN, —CF₃, —C₂F₅, —N(R₄)₂, —N═PPh₃, or —F, each of the R₄ being independently a C₁-C₁₂ alkyl; and

R₇ is H, Li, Na, K, Cs, or (R₄)₃Si—, each of the R₄ being independently a C₁-C₁₂ alkyl,

According to another aspect of the present invention, there is provided a compound of formula (VI): 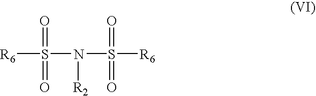
wherein

each of said R₆ is independently —PPh₂, —CN, —CF₃, —C₂F₅, —N(R₄)₂, —N═PPh₃, or —F, each of the R₄ being independently a C₁-C₁₂ alkyl; and

R₂ is H, Li, Na, K, or Cs

The term “alkyl” as used herein refers to linear or branched radicals. Examples of such radicals include, but are not limited to, methyl, ethyl, n-propyl, isopropyl, n-butyl, isobutyl, sec-butyl, tert-butyl, pentyl, iso-amyl, hexyl and the like.

The term “silylamide base” as used herein refers to a base which comprises at least one bond Si—N. It can comprises, for example, two bonds Si—N. Each of the two Si atoms can be connected to three carbon atoms. Suitable examples include, but are not limited to, bis(trialkylsilyl)amide bases, such as lithium bis(trimethylsilyl)amide, sodium bis(trimethylsilyl)amide, or potassium bis(trimethylsilyl)amide.

In the processes of the present invention, the compound of formula (II) can be reacted with the compound of formula (III) at a temperature of about −78 to about 110° C. The temperature can be about −5 to about 25° C. Each of the R₁ can be the same. In one example, R₁ can be Cl or F.

When reacting the compound of formula (II) with the compound of formula (III), the molar ratio (II)/(III) can be about 2:1 to about 15:1. It can also be about 2:1 to about 10:1 or about 2:1 to about 5:1. For example, it can be about 2:1; about 3:1; about 4:1, about 5:1; about 6:1, about 7:1, etc.

The compound of formula (III) can be a compound of formula (IV): 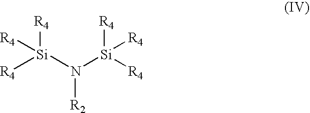
wherein

R₂ is as previously defined in formula (I); and

each of the R₄ is independently a C₁-C₁₂ alkyl.

Each of the R₄ can be the same. In one example, each R₄ can be methyl. In another example, R₂ can be H, Li, Na, or K.

In the process for preparing a compound of formulas (Ia), (V), and (VI) step (b) can be carried out in the presence of an aprotic solvent. Such a solvent can be, for example, a polar solvent such as nitromethane or acetonitrile.

In the process for preparing a compound of formula (Ic), the source of proton can be an organic acid. For example, the organic acid can be chosen from formic acid, trifluoroacetic acid, trifluoromethylsulfonic acid, and HTFSI ((F₃CSO₂)₂NH),. Alternatively, the source of proton can be an inorganic acid. For example, the inorganic acid can be chosen from fluorosulfuric acid, sulfuric acid, nitric acid, phosphoric acid, HPF₆, and HFSI ((FSO₂)₂NH), HBF₄, and a super acid (such as HSbF₆)

In the process for preparing a compound of formula (V) or (VI), according to a specific example, R₆ can be CN, CF₃ or F.

In the use and process for preparing a compound of formula (Ib), the silylamide base can be a bis(trialkylsilyl)amide base for example a bis(trimethylsilyl)amide base.

In the processes of the present invention that comprise more than one step, the steps can be carried out in a single sequence i.e. “one-pot”.

The processes of the present invention are useful for preparing electrolytes. They are also useful for preparing a component of a lithium battery or a solar cell. The process for preparing a compound of formula (I) is useful for preparing an intermediate of bis(fluorosulfonyl)imide or a salt thereof.

### DETAILED DESCRIPTION OF PREFFERED EMBODIMENTS OF THE INVENTION

The following examples represent in a non-limitative manner, preferred embodiments of the present invention.

### EXAMPLE 1

1,1,1,3,3,3-Hexamethyldisilazane (((CH₃)₃Si)₂NH) (1.79 g, 11.1 mmol) was dissolved in 30 mL anhydrous CH₃CN in a 250 mL two-neck flask under Argon at room temperature. Sulfuryl chloride (SO₂Cl₂) (3 g, 22.2 mmol) was then dissolved in 15 mL anhydrous CH₃CN at room temperature and added dropwise over 15 minutes to the reaction mixture under argon at 25° C. The mixture was refluxed during 3 hours. The solvent was then removed under vacuum and the resulting yellowish crude was distilled under vacuum so as to obtain bis(chlorosulfonyl)imide ((ClSO₂)₂NH) in pure form (yield=80%). The obtained product was analyzed by Mass spectrum and elementary analysis. The driving force of this reaction is the formation of the volatile by-product trimethylsilylchloride. This by-product can optionally be recovered and recycled.

Mass Spectrum EI source

214 (M+1)⁺, 179 (M−Cl+1)⁺

M.p. 36° C.

In accordance with one of the process previously described in the present invention, bis(chlorosulfonyl)imide, if desired, can then be converted into bis(fluorosulfonyl)imide by using the process described in US 20040097757, and more particularly in examples 1 to 3. These examples are hereby incorporated by reference.

### EXAMPLE 2

317 g (2.35 mol) of sulfuryl chloride were charged under argon into a 1 L flask and mixed with 500 mL of anhydrous acetonitrile. Then, the mixture was cooled at −20° C. 100 mL (0.47 mol) of hexamethyldisilazane (HMDS 99%) were added dropwise over 30 minutes at −20° C. under argon. The mixture was stirred at room temperature for 12 h and then refluxed for 3 h. Then, the solvent was removed under vacuum and the resulting yellowish crude is dissolved in 500 mL anhydrous acetonitrile and mixed with 163.8 g (2.82 mol) of anhydrous KF. The arising suspension was thoroughly stirred for 72 h. The liquid phase was filtered off and the solvent was removed under vacuum. The resulting solid was recrystallized in ethanol so as to obtain potassium bis(fluorosulfuryl)amide (KFSI) in pure form.

M.p. 99-100° C.

IR (cm⁻¹) KBr: 1403, 1384, 1362, 1226, 1191, 1130, 1116, 859, 845, 784, 748, 729, 583, 572.

### EXAMPLE 3

16.87 g (0.125 mol) of sulfuryl chloride were charged under argon into a 500 mL flask and mixed with 200 mL of anhydrous acetonitrile. Then, the mixture was cooled at −20° C. 100 mL (0.5 M in toluene) of potassium bis(trimethylsilyl)amide were added dropwise over 30 minutes at −20° C. under argon. The mixture was stirred at room temperature for 12 h and then refluxed for 1 h. Then, the solvent was removed under vacuum and the resulting yellowish crude was dissolved in 300 mL anhydrous acetonitrile and mixed with 17.7 g (0.3 mol) of anhydrous KF. The arising suspension was thoroughly stirred for 72 h. The liquid phase was filtered off and the solvent was removed under vacuum. The resulting solid was recrystallized in ethanol so as to obtain potassium bis(fluorosulfuryl)amide (KFSI) in pure form.

The person skilled in the art would also clearly recognize that in the various formulas previously presented, the bound N—R₂ can represent an ionic bond, for example when R₂ represents Li, Na, K, or Cs, or any other cation. The bond N—R₂ can also represent a covalent bond, for example when R₂ represents H.

The person skilled in the art would also recognize that various modifications, adaptations, and variations may be brought to the previously presented preferred embodiments without departing from the scope of the following claims.

1. A process for preparing a compound of formula (I): 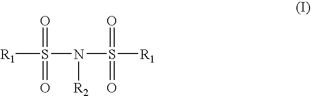
wherein
each of said R₁ is independently F, Cl, Br, or I; and
R₂ is H, Li, Na, K, or Cs,
comprising reacting a compound of formula (II): 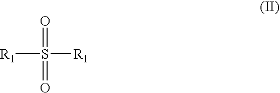
wherein each of said R₁ is as previously defined,
with a compound of formula (III): 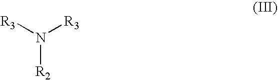
wherein
R₂ is as previously defined for formula (I); and
each of said R₃ is independently H, Li, Na, K, Cs, or (R₄)₃Si—, each of said R₄ being independently a C₁-C₁₂ alkyl.

2. The process of claim 1, wherein said compound of formula (III) is a compound of formula (IV): 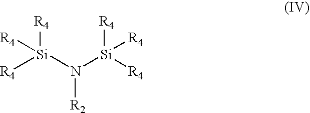
wherein
R₂ is as previously defined in formula (I); and
each of said R₄ is independently a C₁-C₁₂ alkyl.

3. The process of claim 2, wherein each of said R₄ are the same.

4. The process of claim 2, wherein each of said R₄ is methyl.

5. The process of claim 1, wherein said compounds of formulas (II) and (III) are reacted together at a temperature of about −78 to about 110° C.

6. The process of claim 5, wherein said temperature is about −5 to about 25° C.

7. The process of claim 1, wherein each of said R₁ is F.

8. The process of claim 1, wherein each of said R₁ is Cl.

9. The process of claim 1, wherein R₂ is H, Li, Na, or K.

10. The process of claim 2, wherein R₁ is F or Cl, and R₂ is H, Li, Na, or K.

11. The process of claim 4, wherein R₁ is F or Cl, and R₂ is H, Li, Na, or K.

12. A process for preparing a compound of formula (V): 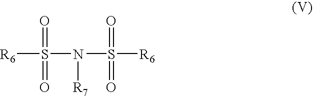
wherein
R₆ is —PPh₂, —CN, —CF₃, —C₂F₅, —N(R₄)₂, —N═PPh₃, or —F, each of said R₄ being independently a C₁-C₁₂ alkyl; and
R₇ is H, Li, Na, K, Cs, or (R₄)₃Si—, each of the R₄ being independently a C₁-C₁₂ alkyl,
said process comprising reacting a compound of formula (I) obtained by the process as defined in claim 1, with a compound of formula R₆—R₇, wherein R₆ and R₇ are as previously defined in formula (V), so as to obtain said compound of formula (V).

13. The process of claim 12, wherein said compound of formula (III) is a compound of formula (IV): 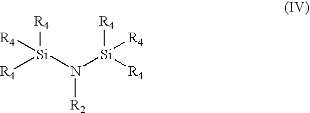
wherein
R₂ is as previously defined in formula (I); and
each of said R₄ is independently a C₁-C₁₂ alkyl.

14. The process of claim 13, wherein R₁ is Cl or F.

15. The process of claim 13, wherein R₇ is Li, Na, or K.

16. The process of claim 13, wherein R₆ is —CN, F, or CF₃.

17. A process for preparing a compound of formula (VI): 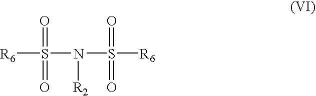
wherein
R₆ is —PPh₂, —CN, —CF₃, —C₂F₅, —N(R₄)₂, —N═PPh₃, or —F, each of said R₄ being independently a C₁-C₁₂ alkyl; and
R₂ is H, Li, Na, K, or Cs;
said process comprising reacting a compound of formula (I) obtained by the process as defined in claim 1, with a compound of formula R₆—R₇, wherein R₆ is as previously defined in formula (V), and R₇ is of formula (R₄)₃Si—, each of said R₄ being independently a C₁-C₁₂ alkyl, so as to obtain said compound of formula (VI).

18. The process of claim 17, wherein said compound of formula (III) is a compound of formula (IV): 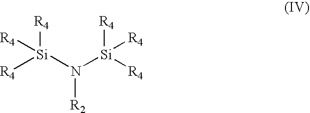
wherein
R₂ is as previously defined in formula (I); and
each of said R₄ is independently a C₁-C₁₂ alkyl.

19. The process of claim 18, wherein R₁ is Cl or F.

20. The process of claim 18, wherein in formula (R₄)₃Si— and in formula (IV), all the R₄ are methyl.

21. The process of claim 18, wherein R₆ is —CN, F, or CF₃.

22. A process for preparing a compound of formula (Ia): 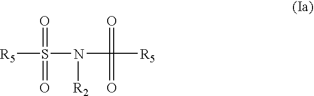
wherein
R₅ is F, Br, Cl or I; and
R₂ is H, Li, Na, K, or Cs,
said process comprising reacting a compound of formula (I) obtained by the process as defined in claim 1, with a compound of formula MR₅, wherein M is H, Li, Na, K, Cs, or is of formula (R₄)₃Si—, each of said R₄ being independently a C₁-C₁₂ alkyl, and R₅ is as previously defined in formula (Ia), so as to obtain said compound of formula (Ia).

23. The process of claim 22, wherein said compound of formula (III) is a compound of formula (IV): 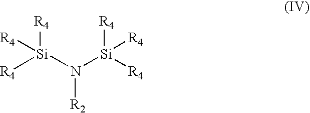
wherein
R₂ is as previously defined in formula (I); and
each of said R₄ is independently a C₁-C₁₂ alkyl.

24. The process of claim 23, wherein R₁ is Cl or F.

25. The process of claim 23, wherein M is Li, Na, K, or is of formula (R₄)₃Si—.

26. The process of claim 23, wherein R₅ is F.

27. A process for preparing a compound of formula (Ic): 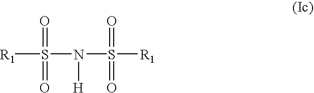
wherein
each of said R₁ is independently F, I, Br, or Cl
said process comprising treating a compound of formula (I) obtained by the process as defined in claim 1, with a source of proton so as to obtain said compound of formula (Ic).

28. The process of claim 27, wherein said compound of formula (III) is a compound of formula (IV): 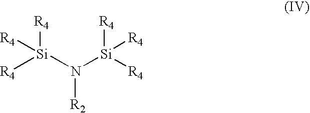
wherein
R₂ is as previously defined in formula (I); and
each of said R₄ is independently a C₁-C₁₂ alkyl.

29. The process of claim 28, wherein R₁ is Cl or F.

30. The process of claim 27, wherein said source of proton is an organic acid chosen from formic acid, trifluoroacetic acid, trifluoromethylsulfonic acid, and HTFSI ((F₃CSO₂)₂NH), or an organic acid chosen from fluorosulfuric acid, HFSI ((FSO₂)₂)NH), sulfuric acid, HPF₆, HBF₄, and a super acid.

31. A method of using a compound of formula (II): 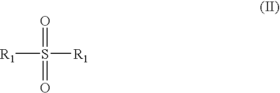
wherein each of the R₁ is independently F, Cl, Br, or I,
said method comprising reacting said compound of formula (II) with a silylamide base in order to produce a sulfonylimide, a salt or derivative thereof.

32. The process of claim 27, wherein said silylamide base is a compound of formula (IV): 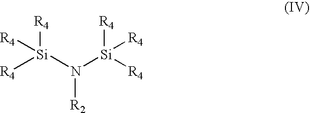
wherein
R₂ is H, Li, Na, K, or Cs; and
each of said R₄ is independently a C₁-C₁₂ alkyl,
and wherein in said compound of formula (II), R₁ is Cl or F.
